(19) United States
(12) Patent Application Publication
(10) Pub. No.: US 2026/0259772 A1
(43) Pub. Date: Sep. 3, 2026

(54) PROCESS PARAMETER OPTIMIZATION METHOD AND SYSTEM

(71) Applicant: National Tsing Hua University, Hsinchu City (TW)

(72) Inventors: Ming-Tsang Lee, Hsinchu City (TW); Yu-Hsun Huang, Hsinchu City (TW); Chih-Ming Ho, Hsinchu City (TW); Da-Jeng Yao, Hsinchu City (TW)

(73) Assignee: National Tsing Hua University, Hsinchu City (TW)

(21) Appl. No.: 19/270,480

(22) Filed: Jul. 16, 2025

(30) Foreign Application Priority Data
Mar. 3, 2025 (TW) 114107766

(51) Int. Cl. G06F 9/50

(52) U.S. Cl. CPC G06F 9/5027

(57) ABSTRACT

A process parameter optimization method and system are provided. Key parameters are selected through a complex system response function to optimize a process, while also predicting an effect after process optimization. A large number of experiments due selection of factors and levels corresponding to the factors in the past experimental method may be greatly reduced, and a result may also be accurately predicted through a small number of experimental groups. Through the process parameter optimization method and system of the disclosure, the number of experiments may be reduced to save time and costs, so as to quickly find an optimal solution.

### CROSS-REFERENCE TO RELATED APPLICATION

This application claims the priority benefit of Taiwan application serial no. 114107766, filed on Mar. 3, 2025. The entirety of the above-mentioned patent application is hereby incorporated by reference herein and made a part of this specification.

### BACKGROUND

### Technical Field

The disclosure relates to a parameter optimization method and system, and more particularly to a process parameter optimization method and system.

### Description of Related Art

As the demand for optoelectronic semiconductor elements increases, the demand for transparent conductive oxide (TCO) and flexible printed circuit (FPC) is also increasing. Taking the TCO process as an example, coating may be performed through reaction jet combined with laser. The main advantage is that circuit patterns of functional materials may be produced on flexible substrates and transparent substrates by means of additive processes, while reducing costs required for other general vacuum environment processes.

However, the reaction jet laser coating technology is easily affected by complex environmental factors, such as environmental temperature and humidity, due to being processed in an atmospheric environment, which may influence process results. Therefore, an efficient method adaptable to complex systems is required to predict and adjust process parameters, and optimize and ensure process stability.

In the prior art, common process stability optimization methods all require a large number of parameters and tests to ensure the reliability and reproducibility of the parameters. However, a large number of tests not only waste materials, but also waste a lot of time. In view of this, how to establish optimized process parameters and predict the effects thereof without conducting a large number of experiments is an important topic.

### SUMMARY

The disclosure provides a process parameter optimization method and system, which achieves quick parameter optimization by a complex system response (CSR) surface method, and performs parameter adjustment according to an optimization result. A physical model corresponding to a complex system is also established through the CSR method to correspond to an actual process and analyze interaction between process parameters.

The disclosure provides a process parameter optimization method, which includes the following steps. Multiple process parameters are input into a process parameter optimization model, and a first detection value is obtained. The process parameters are fitted according to a first complex system response (CSR) function. Multiple key parameters are obtained, and the key parameters are input into the process parameter optimization model to obtain a second detection value. The second detection value is more preferable than the first detection value.

The disclosure also provides a process parameter optimization system, which includes a storage and a processor. The storage stores multiple models. The processor is coupled to the storage and is configured to execute the following operations. Multiple process parameters are input into a process parameter optimization model, and a first detection value is obtained. The process parameters are fitted according to a first complex system response (CSR) function. Multiple key parameters are obtained, and the key parameters are input into the process parameter optimization model to obtain a second detection value. The second detection value is more preferable than the first detection value.

Based on the above, in the process parameter optimization method and system of the disclosure, the key parameters are selected through the complex system response function to optimize the process, while also predicting the effect after process optimization. A large number of experiments due selection of factors and levels corresponding to the factors in the past experimental method may be greatly reduced, and the result may also be accurately predicted through a small number of experimental groups. Through the process parameter optimization method and system of the disclosure, the number of experiments may be reduced to save time and costs, so as to quickly find an optimal solution.

### BRIEF DESCRIPTION OF THE DRAWINGS

FIG. 1 is a flow schematic diagram of a process parameter optimization method according to the disclosure.

FIG. 2 is a schematic diagram of a process parameter optimization system according to the disclosure.

FIG. 3 is a flow schematic diagram of CSR optimization.

FIG. 4 is a scatter diagram of a CSR experimental result according to a first embodiment of the disclosure.

FIG. 5A to FIG. 5C are respectively a parameter response surface diagram according to the first embodiment of the disclosure.

FIG. 6A to FIG. 6C are respectively a parameter first response surface diagram according to a second embodiment of the disclosure.

FIG. 7A to FIG. 7C are respectively a parameter second response surface diagram according to the second embodiment of the disclosure.

FIG. 8 is a Pareto front diagram according to the second embodiment of the disclosure.

### DESCRIPTION OF THE EMBODIMENTS

Reference will now be made in detail to exemplary embodiments of the disclosure, and examples of the exemplary embodiments are illustrated in the drawings. Terms such as “first” and “second” mentioned in the entire specification (including the claims) of the disclosure are used to name elements or distinguish different embodiments or scopes, and are not used to limit the upper limit or the lower limit of the number of elements, nor used to limit the order of the elements. In addition, wherever possible, elements/components with the same reference numerals are used in the drawings and the embodiments to represent the same or similar parts.

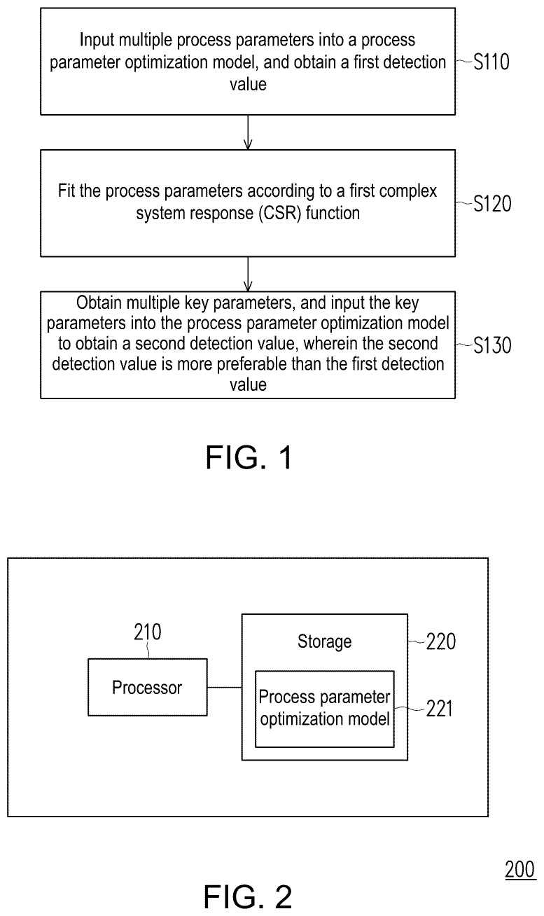

FIG. 1 is a flow schematic diagram of a process parameter optimization method provided by the disclosure. In flow S110, multiple process parameters are input into a process parameter optimization model, and a first detection value is obtained. In flow S120, the process parameters are fitted according to a first complex system response (CSR) function. In flow S130, multiple key parameters are obtained, and the key parameters are input into the process parameter optimization model to obtain a second detection value, wherein the second detection value is more preferable than the first detection value.

FIG. 2 is a schematic diagram of a process parameter optimization system provided by the disclosure. A process parameter optimization system 200 may include a processor 210 and a storage 220.

In the embodiments of the disclosure, the processor is, for example, a central processing unit (CPU), other programmable general-purpose or specific-purpose micro control units (MCU), microprocessors, digital signal processors (DSP), programmable controllers, application specific integrated circuits (ASIC), graphics processing units (GPU), image signal processors (ISP), image processing units (IPU), arithmetic logic units (ALU), complex programmable logic devices (CPLD), field programmable gate arrays (FPGA), other similar elements, or a combination of the above elements. In the process parameter optimization system 200, the processor 210 may be coupled to the storage 220, and the processor 210 may execute each model stored in the storage 220. It should be understood that each flow shown in FIG. 1 of the disclosure may be executed by the processor 210.

The storage 220 is, for example, any type of fixed or removable random-access memory (RAM), read-only memory (ROM), flash memory, hard disk drive (HDD), solid state drive (SSD), similar elements, or a combination of the above elements and is used to store multiple models or various application programs executable by the processor 210. In the embodiment, the storage 220 may store at least a process parameter optimization model 221.

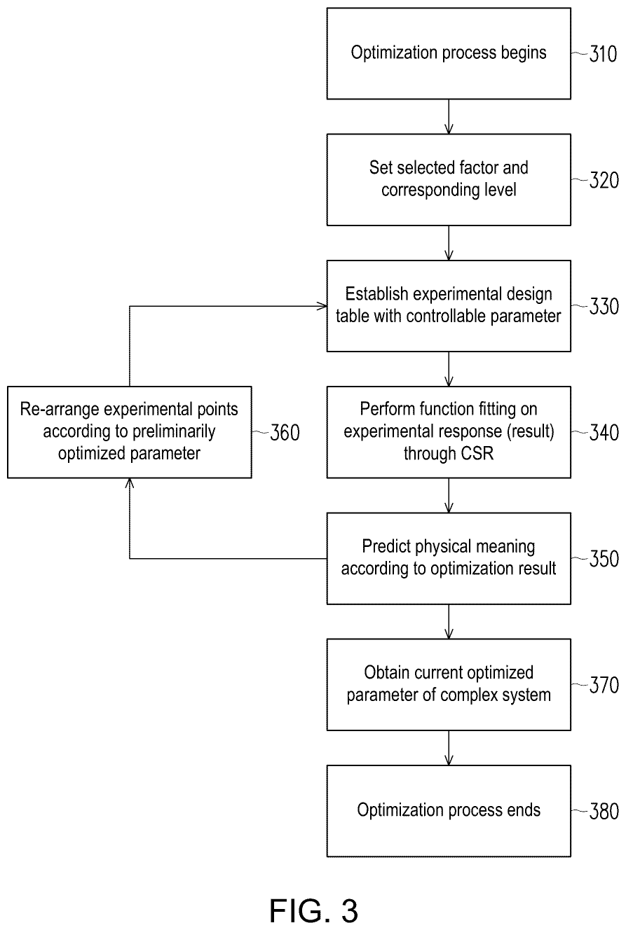

Please refer to FIG. 3. FIG. 3 is a flow schematic diagram of CSR optimization. In flow 310, an optimization process begins. In flow 320, a selected factor and a corresponding level are set. In flow 330, an experimental design table is established with a controllable parameter. In flow 340, function fitting is performed on an experimental response (result) through a CSR. In flow 350, a physical meaning is predicted according to an optimization result. If the result in flow 350 does not conform to the physical meaning, flow 360 is performed to re-arrange experimental points according to a preliminarily optimized parameter. After executing flow 360, the process needs to return to flow 330 to re-execute flow 330 to flow 350. If the result in flow 350 conforms to the physical meaning, flow 370 is executed to obtain a current optimized parameter of a complex system. Finally, the optimization process of flow 380 ends.

In each embodiment of the disclosure, the processor 210 uses an experimental design method and a complex system response (CSR) method to optimize the process. The following uses a laser-assisted atmospheric pressure plasma jet (LAPPJ) as an example to illustrate process optimization. However, the process parameter optimization process applicable to the disclosure is not limited to the foregoing embodiment, and any process that may optimize a process parameter through the method of the disclosure belongs to the scope of the disclosure.

In the embodiment of the disclosure, since coating of transparent conductive oxide through reaction jet combined with laser needs to be performed in an atmospheric environment, complex factors in the environment also influence the process result. Therefore, in the disclosure, multiple environmental factors that may influence the process result may be input into the process parameter optimization model, and key parameters may be adjusted according to the environmental factors to obtain optimized process parameters. In this way, the environmental factors may be taken into consideration in the process without deliberately controlling environmental conditions.

In the embodiment of the disclosure, a function of a complex response surface method used by the processor 210 may plan and provide the minimum number of tests required to optimize properties of a finished product. The function includes 7 forms, and each of the forms may correspond to the minimum number of experiments. It should be understood that the minimum number of experiments is equivalent to the number of function coefficients. As shown in Table 1, which records the feature that the number of experiments may be adaptively adjusted according to data characteristics in the process, and also records the minimum number of experiments corresponding to the selected CSR function.

TABLE 1
Relationship between CSR function and number of experiments

| | | Minimum number of |
|---|---|---|
| Form | CSR function | experiments |
| 1 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{i} ( {c}_{k} , {u}_{x} , t ) {c}_{i} ( t ) dt + {\sum }_{\begin{matrix}i = 1 \\ k \neq i\end{matrix}}^{p} {x}_{ii} ( {c}_{k} , {u}_{x} , t ) {c}_{i}^{2} ( t ) dt + {\sum }_{\begin{matrix}i = 1 \\ k \neq i \\ k \neq j\end{matrix}}^{p - 1} {\sum }_{i \neq j}^{p} {x}_{ij} ( {c}_{k} , {u}_{x} , t ) {c}_{i} ( t ) {c}_{j} ( t ) dt$ | $\frac{{P}^{2} + 3 P + 2}{2}$ |
| 2 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{i} ( {c}_{k} , {u}_{x} , t ) {c}_{i} ( t ) dt + {\sum }_{\begin{matrix}i = 1 \\ k \neq i\end{matrix}}^{p} {x}_{ii} ( {c}_{k} , {u}_{x} , t ) {c}_{i}^{2} ( t ) dt$ | 2P + 1 |
| 3 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{i} ( {c}_{k} , {u}_{x} , t ) {c}_{i} ( t ) dt + {\sum }_{\begin{matrix}i = 1 \\ k \neq i \\ k \neq j\end{matrix}}^{p - 1} {\sum }_{i \neq j}^{p} {x}_{ij} ( {c}_{k} , {u}_{x} , t ) {c}_{i} ( t ) {c}_{j} ( t ) dt$ | $\frac{{P}^{2} + P + 2}{2}$ |
| 4 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{ii} ( {c}_{k} , {u}_{x} , t ) {c}_{i}^{2} ( t ) dt + {\sum }_{\begin{matrix}i = 1 \\ k \neq i \\ k \neq j\end{matrix}}^{p - 1} {\sum }_{i \neq j}^{p} {x}_{ij} ( {c}_{k} , {u}_{x} , t ) {c}_{i} ( t ) {c}_{j} ( t ) dt$ | $\frac{{P}^{2} + P + 2}{2}$ |
| 5 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{i} ( {c}_{k} , {u}_{x} , t ) {c}_{i} ( t ) dt$ | P + 1 |
| 6 | $E ( {c}_{i} , {u}_{x} , t ) dt = {x}_{0} ( {u}_{x} , t ) dt + {\sum }_{\begin{matrix}i = 1 \\ k \neq i\end{matrix}}^{p} {x}_{ii} ( {c}_{k} , {u}_{x} , t ) {c}_{i}^{2} ( t ) dt$ | P + 1 |
| 7 | $E ( {c}_{i} , {u}_{x} , t ) dt = {x}_{0} ( {u}_{x} , t ) dt + {\sum }_{\begin{matrix}i = 1 \\ k \neq i \\ k \neq j\end{matrix}}^{p - 1} {\sum }_{i \neq j}^{p} {x}_{ij} ( {c}_{k} , {u}_{x} , t ) {c}_{i} ( t ) {c}_{j} ( t ) dt$ | $\frac{{P}^{2} - P}{2}$ |

In Table 1, E(cᵢ, uₓ, t) is a response value of a characteristic of interest. In the embodiment of the disclosure, E(cᵢ, uₓ, t) is a resistance value and influences the quality of coating. cᵢ(t) is a process parameter. uₓ is an unknown parameter generated in the complex system. xᵢ(cₖ, uₓ, t) is a linear term and represents the response and the influence of the resistance value of the process result on the process parameter defined by cᵢ(t).

$${c}_{i}^{2} ( t )$$

is a quadratic term of cᵢ(t). xᵢᵢ(cₖ, uₓ, t) is a quadratic coefficient and represents the response of the resistance value to

$${c}_{i}^{2} ( t ) .$$

xᵢⱼ(cₖ, uₓ, t) is an interactive term coefficient and represents an interactive response between resistance value results cᵢ(t) and cⱼ(t). In a fitting function, cᵢ(t) is the level of the parameter and is an independent variable. The coefficients of the function Contain multidimensional response information of the system to parameters and levels, and describe the relationship between the parameter combination and the characteristics of interest. The quantitative relationship may be fitted by the functions listed under Form 1 to Form 7 in Table 1.

In the embodiment of the disclosure, after obtaining the experimental value according to the designed experiment, the response relationship between a parameter and a target value may be obtained through fitting with the CSR function in Table 1. In other words, after the processor 210 receives multiple input process parameters, the processor 210 may select one of the forms of the CSR functions for fitting to select the most suitable form. After obtaining the response relationship, the response relationship between the parameter and the target value may be presented in the form of a surface diagram, thereby obtaining an expected result.

In the embodiment of the disclosure, the processor 210 may first evaluate the characteristic of interest with the CSR function under Form 1 in Table 1. Since the terms included in Form 1 include a linear term, a quadratic term, and a cross term, the processor 210 may preliminarily judge significance of each characteristic to the response value through each coefficient of each term obtained in Form 1, so as to further select other forms in Table 1 for subsequent optimization. For example, when the processor 210 judges that the linear term in the function has no significant influence on the response value, the processor 210 may select the CSR function under Form 4 that does not include the linear term in Table 1 for subsequent parameter optimization.

When conducting experiments using techniques in the prior art, such as the full factorial experimental design, in the case where there are P parameters that may be controlled, each parameter has M levels. Therefore, if search of parameter optimization is performed with the exhaustive algorithm, M^{P} experimental groups are required to obtain optimized parameters. However, when conducting experiments through the CSR function of the disclosure, taking Form 1 as an example, the number of experimental groups required is

$$\frac{{P}^{2} + 3 P + 2}{2} .$$

Table 2 below discloses the comparison between the number of experimental groups required using the CSR function and the full factorial experimental design method, assuming that the number of levels M is 10.

TABLE 2
Comparison between number of experimental groups of CSR function and
full factorial experimental design method

| Number of parameters (P) | $CSR function ( \frac{{P}^{2} + 3 P + 2}{2} )$ | Full factorial experiment (M^{P}) |
|---|---|---|
| 1 | 3 | 10 |
| 2 | 6 | 10² |
| 3 | 10 | 10³ |
| 4 | 15 | 10⁴ |
| 5 | 21 | 10⁵ |
| 6 | 28 | 10⁶ |
| 12 | 91 | 10¹² |

As shown in Table 2, regardless of the number of parameters, the number of experimental groups required when using the CSR function for parameter optimization is always less than the number of groups required for the full factorial experiment.

In the embodiment of the disclosure, a laser-assisted atmospheric pressure plasma jet (LAPPJ) was used as an example. Since the process environment was in an atmospheric environment, the process was easily influenced by factors such as temperature and humidity that are difficult to control or unknown, causing a great difference in resistance values of finished products manufactured each time. The result of the embodiment of the disclosure shows that introducing the CSR into the process may quickly and efficiently obtain the current characteristics of the process equipment, thereby accurately predicting the process result and optimizing the parameters.

As mentioned above, in the embodiment of the disclosure, the processor 210 may select three main factors that influence the resistance value of the process, which are respectively the coating speed, the number of coatings, and the laser power. The parameters used in the experiment and the corresponding response are, for example, as shown in Table 3.

TABLE 3
Process parameter table of laser-assisted
atmospheric pressure plasma jet

| | | Coating | Number of | |
|---|---|---|---|---|
| Experimental | Laser power | speed | coatings | Resistance value |
| round | (Factor 1) | (Factor 2) | (Factor 3) | (Response value) |
| 1 | 14 | 150 | 4 | 176.02 |
| 2 | 14 | 150 | 6 | 115.62 |
| 3 | 14 | 250 | 4 | 533 |
| 4 | 14 | 250 | 6 | 226.44 |
| 5 | 16 | 150 | 4 | 218.32 |
| 6 | 16 | 150 | 6 | 124.33 |
| 7 | 16 | 250 | 4 | 461 |
| 8 | 16 | 250 | 6 | 223.23 |
| 9 | 14 | 150 | 4 | 176.16 |
| 10 | 14 | 200 | 5 | 312 |
| 11 | 14 | 250 | 6 | 229.48 |
| 12 | 15 | 150 | 5 | 133.28 |
| 13 | 15 | 200 | 6 | 171.56 |
| 14 | 15 | 250 | 4 | 475 |
| 15 | 16 | 150 | 6 | 117.7 |
| 16 | 16 | 200 | 4 | 336.6 |
| 17 | 16 | 250 | 5 | 280.12 |

The experimental design was based on the orthogonal array composite design (OACD) experimental design method, and each factor (parameter) was set to correspond to three levels to obtain a global pairing combination. The experimental design was presented with 9 orthogonal arrays plus 8 fractional factorial experiments to obtain 17 experimental groups. However, if a full factorial experiment is used, 27 (3³) groups of experiments are required to obtain the optimized parameters. In this way, the experimental design of the disclosure may reduce the number of experimental groups by 10 groups (approximately 37%). If the CSR function under a different form (a second complex system response function) is selected through Table 1 for fitting to analyze the significance (P-value) of the factor, the number of experimental groups may be further reduced. Taking the embodiment as an example, the minimum number of experimental groups may be reduced to 11 groups, while still maintaining prediction accuracy and stability.

Continuing from the previous paragraph, the formula of the fractional factorial experiment is as follows:

$$N = {2}^{k - p}$$

In the formula of the fractional factorial experiment, N is the required number of experiments, k is the number of factors, and p is the experimental proportion. In the embodiment of the disclosure, a three-factor two-level full factorial experimental design (100% experimental proportion, k=3, and p=0) was used, so an additional 8 (2³) groups of fractional factorial experiments were required.

Continuing from the previous paragraph, the method for reducing the number of experimental groups by the processor 210 is to reduce the number of CSR optimization search groups through significance analysis. The significance analysis may be used as the degree of opposition to the null hypothesis through the P-value. Through defining the null hypothesis (H0) that there is no influence between the factor and the experimental response value (resistance value), two possible results, which are respectively the P-value<0.05 and the P-value≥0.05 of a single factor, are obtained after the significance analysis. When the P-value of a single factor is <0.05, it means that the factor is a significant factor. When the P-value of a single factor is ≥0.05, it means that the factor is not a significant factor in the experiment. In the embodiment, in order to reduce the number of experimental groups, while ensuring the robustness of the experimental design, the processor 210 retains all the experimental groups of the significant factors, removes values of medium levels of the insignificant factors, and only retains the experimental groups of higher levels and lower levels.

In the embodiment, in order to verify the influence of reducing the number of experimental groups on the optimization result, the processor 210 reduces the number of groups of completed experimental results, and the processor 210 verifies the influence of reducing the number of groups on the optimized parameters and the prediction result.

In the embodiment, the processor 210 may first calculate the P-values corresponding to the factors of each experimental group, and obtain that the laser power is the least significant factor among the three factors from the P-values, as shown in Table 4 below.

TABLE 4
P-value greater than or equal to 0.05 represents insignificant factor

| Factor | Parameter | P-value |
|---|---|---|
| Factor 1 | Laser power (%) | *0.4263 |
| Factor 2 | Processing speed (mm/min) | 0.0036 |
| Factor 3 | Processing time (min) | 0.0004 |

As shown in Table 4, the P-value of the laser power was greater than 0.05, so the processor 210 removed the medium level of the laser power in the experimental design. Through testing, it was found that removing repeated groups and medium-level groups by the processor 210 did not influence the prediction model, while the optimized parameters did not change, as shown in Table 5 below.

TABLE 5
Prediction result after removing repeated
group and medium-level group

| Number of | | | | Predicted |
|---|---|---|---|---|
| execution groups | Factor 1 | Factor 2 | Factor 3 | extreme result |
| 17 | 13.75 | 175.00 | 6.00 | 138 |
| 14 | 13.60 | 175.00 | 6.00 | 138 |
| 11 | 13.57 | 175.00 | 6.00 | 141 |
| 9 | 14.00 | 192.47 | 6.00 | 125 |

As shown in Table 5, the number of groups in the original experimental design was 17. The processor 210 obtained 14 experiment groups in Table 5 through removing the repeated experimental groups. The processor 210 obtained 11 experiment groups in Table 5 through removing the medium-level experimental groups of the insignificant factors. The processor 210 obtained 9 experiment groups in Table 5 through removing the higher-level and lower-level groups of the insignificant factors. From the extreme prediction result in Table 5, it can be seen that when the processor 210 removed the medium-level groups of the insignificant factors, the number of experimental groups was reduced, while maintaining the accuracy of model prediction and optimization.

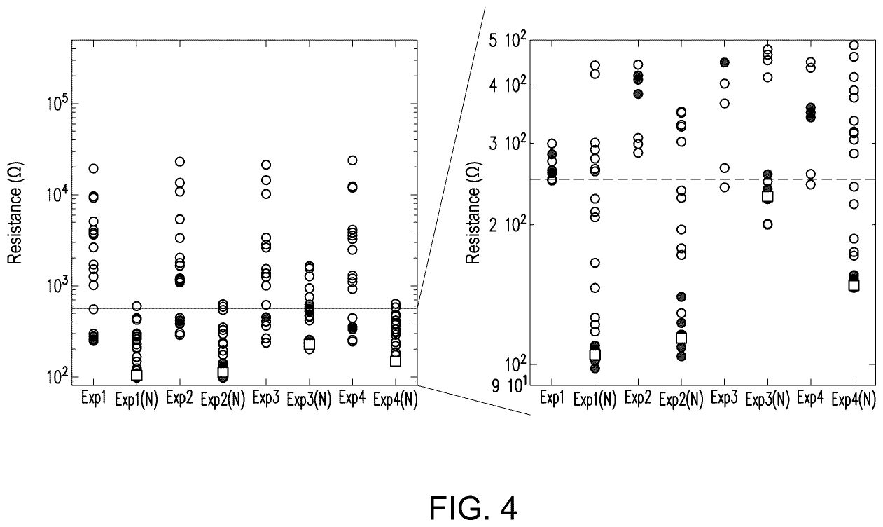

Please refer to FIG. 4. FIG. 4 is a scatter diagram of a CSR experimental result according to a first embodiment of the disclosure and shows the CSR experimental result of the LAPPJ. In FIG. 4, the horizontal axis represents two experiments, which are respectively the first experiment with a larger parameter search range and a more refined optimized parameter search with a moderately narrowed parameter search range according to the prediction result of the CSR model established by data of the first experiment, respectively conducted at four different time periods. Therefore, there are eight groups of data. The vertical axis is the resistance value (Ω). The black hollow circles are experimental resistance values obtained via actual experiments according to 17 groups of the OACD experimental design method. The parameters are optimized through the CSR method. The meaning of the black hollow circles is original data for constructing a quadratic surface model corresponding to the current experiment. The black solid circles are the resistance values applied to the process using the optimized parameters, and the hollow squares are the resistance values corresponding to using the optimized parameters predicted by the disclosure.

Please continue to refer to FIG. 4. The error between the predicted resistance value and the actual resistance value is only 4%, and the correlation coefficient of the response model fitted by the CSR is as high as 0.98, which proves that CSR technology may be applied to optimization and prediction of laser process parameters in the atmospheric environment. In other words, predicting the use of the optimized parameters of the disclosure in the process through the disclosure may provide the user with an accurate expected result.

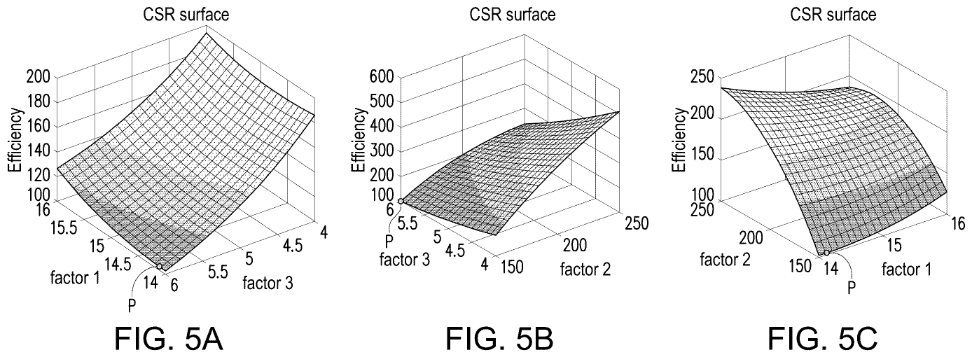

In the embodiment of the disclosure, it can be seen from the content of Table 1 that different parameters may interact with each other. Therefore, the disclosure further presents the response values between the factors in the form of a quadratic surface in the embodiment. Taking the embodiment of the disclosure as an example, the three factors may interact with each other to obtain three diagrams. Please refer to FIG. 5A to FIG. 5C. FIG. 5A to FIG. 5C are respectively a parameter response surface diagram according to the first embodiment of the disclosure. In FIG. 5A to FIG. 5C, CSR surfaces between different factors are respectively presented. In FIG. 5A, FIG. 5B, and FIG. 5C, a hollow circle P represents the predicted response value, and through the predicted response value, the interaction between the factors and the influence on the process result can be known.

In the embodiment of the disclosure, the fitting equation used by the CSR is the quadratic response surface equation in Table 1. Under the condition of three factors and three levels, the equation has a total of 10 coefficients, as shown in Equation (1) below, where C₁ represents Factor 1, C₂ is Factor 2, C₃ is Factor 3, and Response is the resistance value of interest in the example.

$$Response = ( - 22.05 ) + ( - 163.65 ) {C}_{1} + ( 6.95 ) {C}_{1}^{2} + ( 17.43 ) {C}_{2} + ( - 0.01 ) {C}_{2}^{2} + ( - 50.03 ) {C}_{3} + ( 9.82 ) {C}_{3}^{2} + ( - 0.99 ) {C}_{2} {C}_{3} + ( 4.20 ) {C}_{1} {C}_{3} + ( - 0.38 ) {C}_{1} {C}_{2} \qquad ( 1 )$$

In a second embodiment of the disclosure, taking aerosol jet printing and laser direct synthesis patterning (AJP-LDSP) as an example, a complex system response function is used in combination with a multi-objective optimization algorithm to adjust the process parameters to obtain the lowest resistance value, the line width difference, and the processing time. Since the process is easily affected by uncontrollable factors such as temperature and humidity, aerosol atomization and deposition conditions are different in each process, and the resistance value and the line width also differ greatly. In the second embodiment, the three main factors are the carrier gas flow rate, the laser power, and the processing rate. The parameters used in the experiment and the corresponding response are, for example, as shown in Table 6.

TABLE 6
Process parameter table of aerosol jet printing
and laser direct synthesis patterning

| | | | | Resistance | Line width |
|---|---|---|---|---|---|
| Experi- | Carrier gas | Laser | Processing | value | difference |
| mental | flow rate | power | rate | (Response | (Response |
| round | (Factor 1) | (Factor 2) | (Factor 3) | value 1) | value 2) |
| 1 | 50 | 6.5 | 60 | 1.60 | 87.46 |
| 2 | 50 | 6.5 | 120 | 3.62 | 95.90 |
| 3 | 50 | 7.5 | 60 | 1.77 | 82.68 |
| 4 | 50 | 7.5 | 120 | 3.06 | 87.96 |
| 5 | 100 | 6.5 | 60 | 0.36 | 6.61 |
| 6 | 100 | 6.5 | 120 | 1.08 | 37.74 |
| 7 | 100 | 7.5 | 60 | 0.38 | 18.05 |
| 8 | 100 | 7.5 | 120 | 0.84 | 35.08 |
| 9 | 50 | 6.5 | 60 | 1.74 | 90.90 |
| 10 | 50 | 7 | 90 | 2.52 | 95.21 |
| 11 | 50 | 7.5 | 120 | 2.80 | 93.25 |
| 12 | 75 | 6.5 | 90 | 1.14 | 71.76 |
| 13 | 75 | 7 | 120 | 1.15 | 73.12 |
| 14 | 75 | 7.5 | 60 | 0.40 | 46.55 |
| 15 | 100 | 6.5 | 120 | 0.98 | 35.76 |
| 16 | 100 | 7 | 60 | 0.37 | 13.49 |
| 17 | 100 | 7.5 | 90 | 0.63 | 31.73 |

The second embodiment of the disclosure uses the same experimental design as the first embodiment, that is, each factor (parameter) is set to correspond to three levels based on the orthogonal array composite design experimental design method to obtain the global pairing combination. The experimental design is presented with 9 orthogonal arrays plus 8 fractional factorial experiments to obtain 17 experimental groups. However, if a full factorial experiment is used, 27 (3³) groups of experiments are required to obtain the optimized parameters. In this way, the number of experimental groups is reduced by 10 groups (approximately 37%). If the CSR function under a different form (the second complex system response function) is selected through Table 1 for fitting to analyze the significance (P-value) of the factor, the number of experimental groups may be further reduced. The CSR function used in the embodiment uses only 17 experimental groups, and the model accuracy correlation coefficients R² of the fitted resistance value and line width difference may respectively reach 0.992 and 0.993.

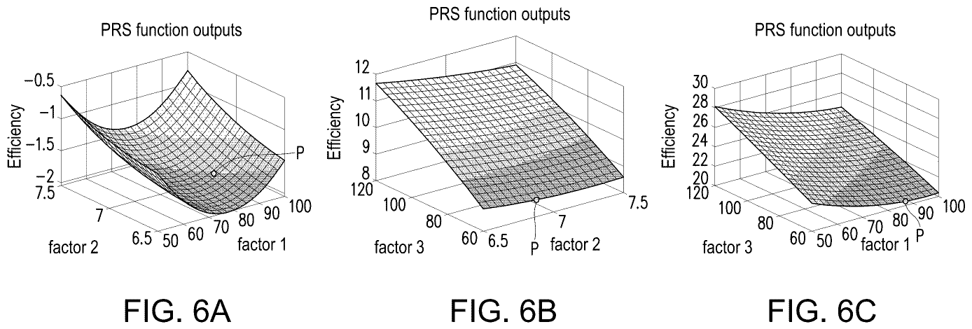

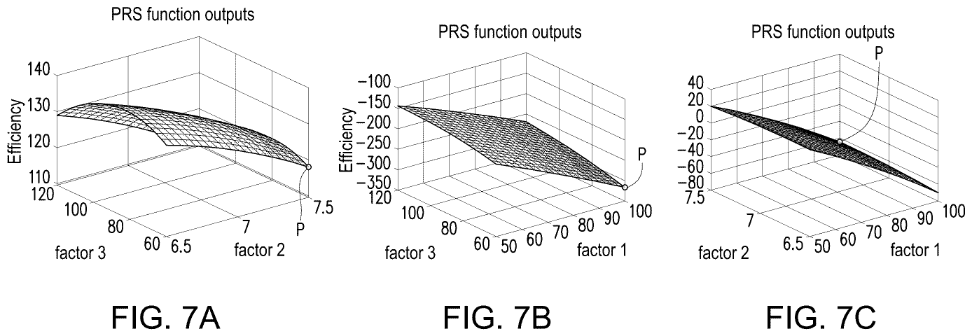

Please refer to FIG. 6A to FIG. 6C and FIG. 7A to FIG. 7C at the same time. FIG. 6A to FIG. 6C are respectively a parameter first response surface diagram according to the second embodiment of the disclosure, and FIG. 7A to FIG. 7C are respectively a parameter second response surface diagram according to the second embodiment of the disclosure. In FIG. 6, CSR surfaces between different factors are presented to obtain the influence on the response value of the resistance value. In FIG. 6A, FIG. 6B, and FIG. 6C, a hollow circle P represents the predicted response value, and through the predicted response value, the interaction between the factors and the response value of the resistance value of the process result can be known. In FIG. 7, CSR surfaces between different factors are presented to obtain the influence on the response value of the line width difference. In FIG. 7A, FIG. 7B, and FIG. 7C, a hollow circle P represents the predicted response value, and through the predicted response value, the interaction between the factors and the response value of the line width difference of the process result can be known.

In the second embodiment of the disclosure, the fitting equation used by the CSR is the quadratic response surface equation in Table 1. Under the condition of three factors and three levels, the equation has a total of 10 coefficients, as shown in Equation (2) and Equation (3) below, where C₁ represents Factor 1, C₂ is Factor 2, C₃ is Factor 3, Response₁ is the resistance value, and Response₂ is the line width difference.

$${Response}_{1} = ( 23.70 ) + ( - 0.20 ) {C}_{1} + ( 0.0011 ) {C}_{1}^{2} + ( - 5.69 ) {C}_{2} + ( 0.4308 ) {C}_{2}^{2} + ( 0.13 ) {C}_{3} + ( - 0.0001 ) {C}_{3}^{2} + ( - 0.0090 ) {C}_{2} {C}_{3} + ( - 0.0004 ) {C}_{1} {C}_{3} + ( 0.0036 ) {C}_{1} {C}_{2} \qquad ( 2 )$$

$${Response}_{2} = ( - 121.61 ) + ( - 2.28 ) {C}_{1} + ( - 0.0064 ) {C}_{1}^{2} + ( 72.28 ) {C}_{2} + ( - 6.1780 ) {C}_{2}^{2} + ( 1.52 ) {C}_{3} + ( - 0.0074 ) {C}_{3}^{2} + ( - 0.04357 ) {C}_{2} {C}_{3} + ( 0.0054 ) {C}_{1} {C}_{3} + ( 0.2062 ) {C}_{1} {C}_{2} \qquad ( 3 )$$

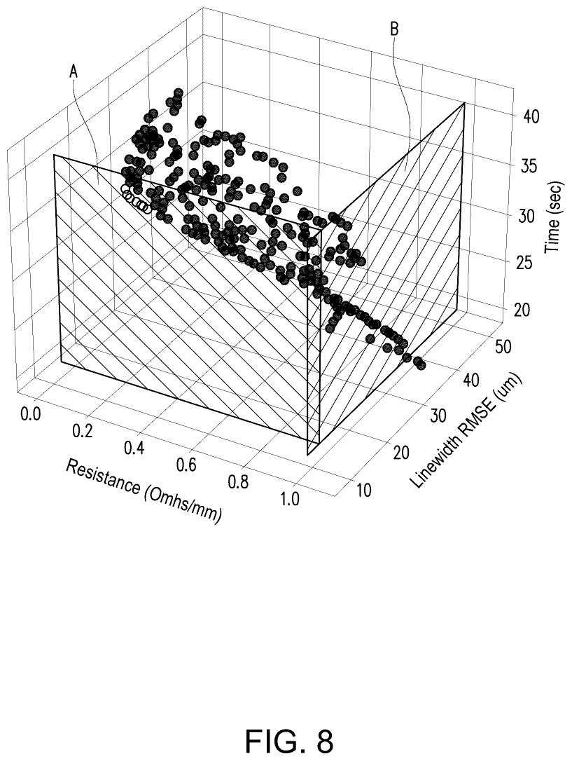

In the second embodiment of the disclosure, the three factors (carrier gas flow rate, laser power, and processing rate) are used as inputs, and the resistance value, the line width difference, and the process time corresponding to different processing rates predicted by the CSR model are used as outputs. By the multi-objective optimization algorithm, an optimal solution set of multiple objectives, that is, a Pareto front, and a corresponding process parameter combination may be calculated. Through the Pareto front, the process parameter combination with the shortest process time conforming to specification conditions of the finished product may be filtered out. Please refer to FIG. 8. FIG. 8 is a Pareto front diagram according to the second embodiment of the disclosure. In FIG. 8, the solid black circles are solutions that do not conform to the conditions, the hollow black circles are solutions that conform to the conditions, a surface A is the line width difference condition, and a surface B is the resistance condition. The comparison between the predicted values of an optimal solution and the experimental values is as shown in Table 7. As shown in Table 7, the experimental results are almost the same as the predicted results, and there is a high correlation.

TABLE 7
Comparison between optimal solution and
experimental value of second embodiment

| | Factor | Factor | Factor | Response | Response | |
|---|---|---|---|---|---|---|
| | 1 | 2 | 3 | 1 | 2 | Time |
| Predicted | 99.9 | 6.6 | 60 | 0.3 | 10.7 | 39.9 |
| value | | | | | | |
| Experimental | 100 | 6.6 | 60 | 0.4 | 7.4 | 40 |
| value | | | | | | |

It should be understood that in the embodiment of the disclosure, after each process parameter optimization model, the processor 210 may perform a detection to obtain a detection value, and the detection value is related to prediction accuracy and stability.

In each embodiment of the disclosure, the processor 210 may plan the number of experiments through comparing the selected form of the CSR function in Table 1. The processor 210 may determine which form to select for planning the number of experiments through, for example, analyzing whether the significance of the factor is less than 0.05.

In each embodiment of the disclosure, after obtaining the optimized key parameters using the CSR function, the processor 210 further predicts whether the process result obtained using the optimized parameters conforms to the physical meaning. If the process result conforms to the physical meaning, the processor 210 outputs the key parameters for use in subsequent processes. Conforming to the physical meaning is, for example, that the resistance value is greater than zero. In other experiments, conforming to the physical meaning may be, for example, that a mass value of an output product is positive.

In summary, in the process parameter optimization method and system of the disclosure, the key parameters are selected through the complex system response function to optimize the process, while also predicting the effect after process optimization. A large number of experiments due the selection of the factors and the levels corresponding to the factors in the past experimental method may be greatly reduced, and the result may also be accurately predicted through a small number of experimental groups. Through the process parameter optimization method and system of the disclosure, the number of experiments may be reduced to save time and costs, so as to quickly find the optimal solution.

What is claimed is:

1. A process parameter optimization method, comprising:
inputting a plurality of process parameters into a process parameter optimization model, and obtaining a first detection value;
fitting the process parameters according to a first complex system response (CSR) function; and
obtaining a plurality of key parameters, and inputting the key parameters into the process parameter optimization model to obtain a second detection value, wherein the second detection value is more preferable than the first detection value.

2. The process parameter optimization method according to claim 1, further comprising:
inputting a plurality of environmental factors into the process parameter optimization model; and
adjusting the key parameters according to the environmental factors.

3. The process parameter optimization method according to claim 1, further comprising:
fitting the process parameters according to a second complex system response function; and
obtaining the key parameters.

4. The process parameter optimization method according to claim 3, further comprising:
planning a number of experiments according to the selected first complex system response function or the selected second complex system response function.

5. The process parameter optimization method according to claim 1, further comprising:
in response to the second detection value conforming to a physical meaning, outputting the key parameters.

6. The process parameter optimization method according to claim 5, wherein the physical meaning comprises a resistance value greater than zero.

7. The process parameter optimization method according to claim 1, further comprising:
obtaining a global pairing combination according to an orthogonal array composite design (OACD) and according to the process parameters and a level combination, wherein the global pairing combination is related to the key parameters.

8. The process parameter optimization method according to claim 1, further comprising:
obtaining a number of experiments according to the first complex system response function, wherein the number of experiments is related to the process parameters.

9. The process parameter optimization method according to claim 1, wherein the process parameters comprise coating speed, number of coatings, and laser power.

10. A process parameter optimization system, comprising:
a storage, storing a plurality of models; and
a processor, coupled to the storage and configured to:
input a plurality of process parameters into a process parameter optimization model among the models, and obtain a first detection value;
fit the process parameters according to a first complex system response (CSR) function; and
obtain a plurality of key parameters, and input the key parameters into the process parameter optimization model to obtain a second detection value, wherein the second detection value is more preferable than the first detection value.

11. The process parameter optimization system according to claim 10, wherein the processor is further configured to:
input a plurality of environmental factors into the process parameter optimization model; and
adjust the key parameters according to the environmental factors.

12. The process parameter optimization system according to claim 10, wherein the processor is further configured to:
fit the process parameters according to a second complex system response function; and
obtain the key parameters.

13. The process parameter optimization system according to claim 12, wherein the processor is further configured to:
plan a number of experiments according to the selected first complex system response function or the selected second complex system response function.

14. The process parameter optimization system according to claim 10, wherein the processor is further configured to:
in response to the second detection value conforming to a physical meaning, output the key parameters.

15. The process parameter optimization system according to claim 14, wherein the physical meaning comprises a resistance value greater than zero.

16. The process parameter optimization system according to claim 10, wherein the processor is further configured to:
obtain a global pairing combination according to an orthogonal array composite design (OACD) and according to the process parameters and a level combination, wherein the global pairing combination is related to the key parameters.

17. The process parameter optimization system according to claim 10, wherein the processor is further configured to:
obtain a number of experiments according to the first complex system response function, wherein the number of experiments is related to the process parameters.

18. The process parameter optimization system according to claim 10, wherein the process parameters comprise coating speed, number of coatings, and laser power.
